(19) United States
(12) Patent Application Publication
(10) Pub. No.: US 2014/0216668 A1
(43) Pub. Date: Aug. 7, 2014

(54) ROLL BLIND HAVING SAFETY CORD

(71) Applicant: Jung-Min Kim, Yangju-si (KR)

(72) Inventor: Jung-Min Kim, Yangju-si (KR)

(21) Appl. No.: 14/240,880

(22) PCT Filed: Aug. 25, 2011
(86) PCT No.: PCT/KR2011/006273

§ 371 Date: Feb. 25, 2014

(51) Int. Cl. E06B 9/42

(52) U.S. Cl. CPC E06B 9/42
USPC 160/322

(57) ABSTRACT

A roll blind with a single safety cord is provided in which an ascending cord and a descending cord configured to ascend and descend a blind sheet are integrated in a single safety cord. When it needs to descend a blind sheet, the single safety cord is pulled forward, and the clutches are disengaged, so the blind sheet can be fast descended. When it needs to ascend the blind sheet, the single safety cord is repeatedly pulled right downward, the blind sheet can be easily ascended. Once the single safety cord is pulled downward, it can be automatically returned to its original position based on an origin position ascending and returning function, so a user can easily ascend the blind sheet. The single safety cord is made shorter and is positioned higher where a kid's hand does not reach, so it is possible to prevent a kid or a weak person from choking or stumbling over and falling down.

### BACKGROUND

The present invention relates to a roll blind device which can block the input of sunshine from outside and can protect indoor private life, and more particularly to a roll blind with a single safety cord which roll blind is equipped with an integrated single safety cord formed of an ascending cord and a descending cord both configured to ascend and descend a blind sheet.

A typical roll blind is in general installed at the windows of various buildings so as to block the input of sunshine from outside while controlling the brightness of light in an indoor space and protecting indoor private life.

The above mentioned typical roll blind comprises a blind sheet or a plurality of blind sheets which are installed in a horizontal direction.

The thusly installed blind sheet is rolled up and wound on a winding rod installed at top and is stored or is rolled down from the winding rod when it needs to block the sunshine in such a way to cover the window.

The typical roll blind comprises a driving bracket and a driven bracket at either side of a frame which is fixed on a wall.

A pipe-shaped winding rod is rotatably installed between the driving bracket and the driven bracket, and a blind sheet is wound on the winding rod.

A weight is hanging from the bottom of the blind sheet, so the blind sheet can roll down from the winding rod with the aid of the weight.

In the typical roll blind, a cord pulley is provided in the driving bracket and is integrally connected to the winding rod and rotates.

An endless loop chain type pulling cord is wound on the cored pulley.

When a user grabs one end of the pulling cord and pulls down it, the winding rod rotates in one direction based on the operations of the cord pulley.

The rotation of the winding rod makes the blind sheet roll up and ascend.

When the user grabs the other end of the pulling cord and pulls down it, the cord pulley rotates in the reverse direction.

The reverse rotation of the cord pulley makes the winding rod rotate in the reverse direction, so the blind sheet is rolled down from the winding rod and descend.

The pulling cord is formed in an endless loop type and is wound on the cord pulley, with the bottom of the pulling cord handing downward. The above described pulling cord may cause some problems.

For example, kids may hide behind the blind sheet while playing a hide-and-seek game with their friends. In this case, the pulling cord which is hanging downward in an endless loop type may be wound on a kid's neck and may choke the kid.

The above mentioned kind's neck choking accident by the pulling cord is very serious because if the kid whose neck is wound by the pulling cord falls down, the kid may choke and die.

Kids or weak persons may stumble over such an endless loop type pulling cord of the roll blind device and fall down while they walk or run indoors.

In order to improve the above mentioned problems, it needs not to allow the pulling cord, which is handing downward in an endless loop type, to be connected with each other while positioning higher the pulling cord.

It further needs to position the pulling cord at a position where kids' hands cannot reach, so that the kids or weak persons don't stumble over and fall down; however the typical roll blind is impossible to make the pulling cord shorter by disengaging the bottom of the pulling cord and to position it higher so that kinds cannot reach.

In the industry, it is urgent to develop a new roll blind which overcomes the above mentioned problems.

### SUMMARY OF THE INVENTION

Accordingly, the present invention is made so as to improve the above mentioned problems. It is an object of the present invention to provide a roll blind with a single safety cord which has features in that a puling cord designed to ascend and descend a blind sheet is formed of a safety cord, and the safety cord is made shorter and is positioned so that a kid's hand cannot reach.

It is another object of the present invention to provide a roll blind with a single safety cord which makes it possible to prevent an accident such as a neck choking accident during the use of a roll blind and an accident which used to take place before as a kid or a weak person stumbles over a pulling cord and falls down.

It is further another object of the present invention to provide a roll blind with a single safety cord which has features in that when a single safety cord is directly pulled by a force, it can be used as an ascending cord which ascends a blind sheet.

It is further another object of the present invention to provide a roll blind with a single safety cord which has features in that once a single safety cord is pulled down, the single safety cord can automatically return to its original position based on an original position returning function.

It is further another object of the present invention to provide a roll blind with a single safety cord which has features in that when a single safety cord is pulled forward with a certain inclination, it can be used as a descending cord with which to descend a blind sheet.

It is further another object of the present invention to provide a roll blind with a single safety cord which has features in that when a state that a single safety cord is pulled forward with a certain inclination is changed into its original state, more specifically, the forwardly pulled state of the single safety cord returns to its original state, the descending of the blind sheet stops.

To achieve the above objects, there is provided a roll blind with a single safety cord for a roll blind device which is made to wind a blind sheet on a winding rod and store the wound blind sheet or when in use to unwind it from the winding rod, comprising a winding part by which as a driving connector connected to one side of the winding rod rotates in one direction, the blind sheet wound on the winding rod ascends, and as the driving connector and the winding rod rotate in the other direction, the blind sheet descends; an ascending operation part including a movable clutch which slide-engages in an axial direction at an inner side of the driving connector; and a rotation clutch which is rotatable at an inner side of the driving connector, wherein in the movable clutch and the rotation clutch, the opposite clutches are engaged or disengaged as the movable clutch moves left or right, and in a state that the rotation clutch and the movable clutch are engaged, the blind sheet can ascend by pulling right downward a single safety cord of the cord pulley connected to the rotation clutch; and a descending operation part by which the blind sheet can descend in such a way to rotate the movable clutch and to disengage from the rotatable clutch by pulling forward the single safety cord and rotating a descending adjusting lever with the aid of an engaging member, wherein the descending adjusting lever is disposed at one side of the movable clutch, and a lower end of the descending adjusting lever forms the engaging member at a forward side of the single safety cord.

Preferably, a support cap is integrally fixed at an end of one side of the driving connector, and a central portion of the support cap is rotatably inserted into a circular outer circumferential surface of the central shaft, and a clutch recovery spring is coaxially inserted into a surrounding of the central haft at an inner side of the support cap, and one side of the clutch recovery spring is supported by an inner surface of the support cap, and the other side of the clutch recovery spring is supported by a back surface of the movable clutch, and the movable clutch comes into close contact all the way toward the rotatable clutch and is elastically supported.

Preferably, a plurality of sliding protrusions are formed on an outer circumferential surface of the movable clutch, and the sliding protrusions are movably inserted into a plurality of sliding grooves formed in an axial direction on an inner circumferential surface of the driving connector, so the movable clutch is prevented from rotating in a circumferential direction with respect to the driving connector and becomes movable in an axial direction of the central shaft in the interior of the driving connector, and the rotation clutch comprises a cord pulley, one side of the rotation clutch being rotatably inserted into the cord pulley, and a plurality of one-way poles protruding from the cord pulley are tooth-engaged with one side of a tooth portion of an outer circumferential surface of the rotation clutch, and in a state that the rotatable clutch and the movable clutch are engaged, when the single safety cord wound on the cord pulley is pulled right downward, the driving connector rotates in one direction with the aid of the rotations of the rotatable clutch and the movable clutch, so the blind sheet is wound on the winding rod and ascends.

Preferably, a ring shaped concave groove on which to wind a single safety cord is formed at an outer circumferential surface of the cord pulley, and the plurality of the first one-way poles extend with an inclination toward one side of the tooth part of an outer circumferential surface of the rotation clutch at its one side, and the ends of the first one-way poles are tooth-engaged, and when the cord pulley rotates as the single safety cord is downwardly pulled, the cord pulley and the rotation clutch rotate in the same direction.

Preferably, a circular rod-shaped pusher is inserted in the movable clutch so that the movable clutch can slide in the interior of the shaft hole of the central shaft, and an end of one side of the pusher passes through a bracket at which the central shaft is fixed, and comes into close contact with an inclined surface of the top of the descending adjusting lever, and an end of the other side of the pusher is disposed in such a way that a pressing rod protrudes in both directions from a longitudinal hole formed in an axial direction of the central shaft and is supported by one side of the movable clutch, and an intermediate portion of the descending adjusting lever is rotatably engaged at a hinge shaft of the bottom of a support plate fixed at a surface of the other side of the bracket, and a distortion spring is disposed in the hinge shaft, so that the descending adjusting lever can elastically stand upright, and when the movable clutch is disengaged from the rotation clutch by pulling the single safety cord forward, the blind sheet can unwind from the winding rod and descends as the weight of the blind sheet allows the driving connector and the winding rod to freely rotate in the direction of the other side.

Preferably, when the engaging member of the bottom of the descending adjusting lever is pulled forward via the single safety cord, the distortion spring stores elastic recovery force and bends, and the descending adjusting lever rotates with an inclination, and a thick portion of the inclined surface of the top of the descending adjusting lever comes into contact with one side of the pusher and slides the pusher in the interior of the shaft hole, and the pressing rod of the pusher is positioned at one side in the longitudinal hole of the central shaft, and the movable clutch moves away from the rotation clutch, so the clutches are disengaged, and when the forwardly pulled state of the single safety cord is released, the torsion spring allows a thin portion of the inclined surface of the top of the descending adjusting lever to come contact with one side of the pusher, and the pressing rod of the pusher is positioned at the other side in the interior of the central shaft, so the clutches of the movable clutch and the rotation clutch are engaged, and the rotations of the driving connector and the winding rod are stopped, and the descending of the blind sheet is stopped.

Preferably, the distortion spring is disposed in a space formed between the support plate and the bracket, and an end of one side of the distortion spring is fixed at the descending adjusting lever, and an end of the other of the distortion spring is fixed at the support plate, so elastic recovery force can be accumulated during the rotations of the descending adjusting lever, and an inner surface of the support plate supports a side surface of the opposite side of the inclined surface of the top of the descending adjusting lever, so the inclined surface can be supported by a side surface of the pusher.

Preferably, at one side of the cord pulley is provided a reverse rotation prevention part which is formed of a brake latch one side of which is fixed at the bracket, for thereby preventing the rotation clutch from rotating in reverse direction, and in the brake latch, the second one-way poles are tooth-engaged with the other side of the tooth part of an outer circumferential surface of the rotation clutch, and the second one-way poles extend with an inclination side by side in the same direction as the first one-way poles, and the ends of the second one-way poles are tooth-engaged with an inclination with the other side of the tooth part of an outer circumferential surface of the rotation clutch for thereby preventing the rotation clutch from rotating in a reverse direction.

Preferably, there is further provided a cord returning part formed of a pulley recovery spring which accumulates an elastic recovery force when the cord pulley rotates in one direction by pulling the single safety cord downward, the cord returning part rotating the cord pulley in reverse direction using an elastic force accumulated in the pulley recovery spring, and winding the single safety cord on the cord pulley and ascending and returning to its original position, and the pulley recovery spring is positioned around the central shaft at an inner side of the cord pulley, and an end of one side of the pulley recovery spring is fixed at an inner side surface of the cord pulley, and an end of the other side of the pulley recovery spring is fixed at a bushing which is fixedly inserted into a hexagonal part of the central shaft, and when the cord pulley rotates by the downward pulling of the single safety cord, the pulley recovery spring accumulates distortion elastic force, and when the downwardly pulled state of the single safety cord is released, the cord pulley is rotated in reverse direction by the distortion elastic recovery force of the pulley recovery spring, and the single safety cord is wound on the cord pulley and ascends and returns to its original position, and the user pulls again right downward the single safety cord, which has returned to its original position, for thereby further ascending the blind sheet, so the blind sheet can be ascended to a certain height by repeatedly performing the above procedures.

Preferably, the cord returning part is configured in such a way that when the cord pulley rotates in reverse direction by means of the pulley recovery spring, the first one-way poles of the cord pulley elastically bend, and move over one side of the tooth part of an outer circumferential surface of the rotation clutch, and the reverse rotation of the rotation clutch is stopped as the second one-way poles of the brake latch are engaged with the other side of the tooth part of an outer circumferential surface of the rotation clutch.

According to the present invention, when it needs to descend a blind sheet, the blind sheet can be fast descended by disengaging a clutch in such a way to pull a single safety cord in a forward direction.

According to the present invention, when it needs to ascend a blind sheet, the blind sheet can be ascended by repeatedly pulling a single safety cord in a right downward direction.

According to the present invention, when a single safety cord is pulled in a downward direction, the single safety cord can automatically return to its original position, so an ascending return operation can be performed, and a user can continuously ascend a blind sheet in an easier way.

According to the present invention, a single safety cord is made shorter, and it can be positioned higher so that a kid's hand cannot reach, so it is possible to prevent a kid's neck choking accident and a kid or weak person from stumbling over and falling down.

### BRIEF DESCRIPTION OF THE DRAWINGS

FIG. 1 is a side cross sectional view illustrating a roll blind with a single safety cord according to the present invention.

FIG. 2 is a side cross sectional view illustrating disassembled driving elements of a roll blind accord with a single safety cord according to the present invention.

FIG. 3 is a front and side cross sectional view for describing an ascending operation of a blind sheet of a roll blind with a single safety cord according to the present invention.

FIG. 4 is a front and side cross sectional view for describing a descending operation of a blind sheet of a roll blind with a single safety cord according to the present invention.

FIG. 5A is an enlarged front cross sectional view for describing an engaging operation between a movable clutch and a rotation clutch during an ascending operation of a blind sheet of a roll blind with a single safety cord according to the present invention.

FIG. 5B is an enlarged front cross sectional view for describing a disengaging operation between a movable clutch and a rotation clutch during a descending operation of a blind sheet of a roll blind with a single safety cord according to the present invention.

FIG. 6A is a view for describing an engaging relationship of a cord pulley and a rotation clutch of a roll blind with a single safety cord according to the present invention.

FIG. 6B is a view for describing a brake latch and a rotation clutch of a roll blind with a single safety cord according to the present invention.

### DETAILED DESCRIPTION OF THE INVENTION

The preferred embodiments of the present invention will be described with reference to the accompanying drawings.

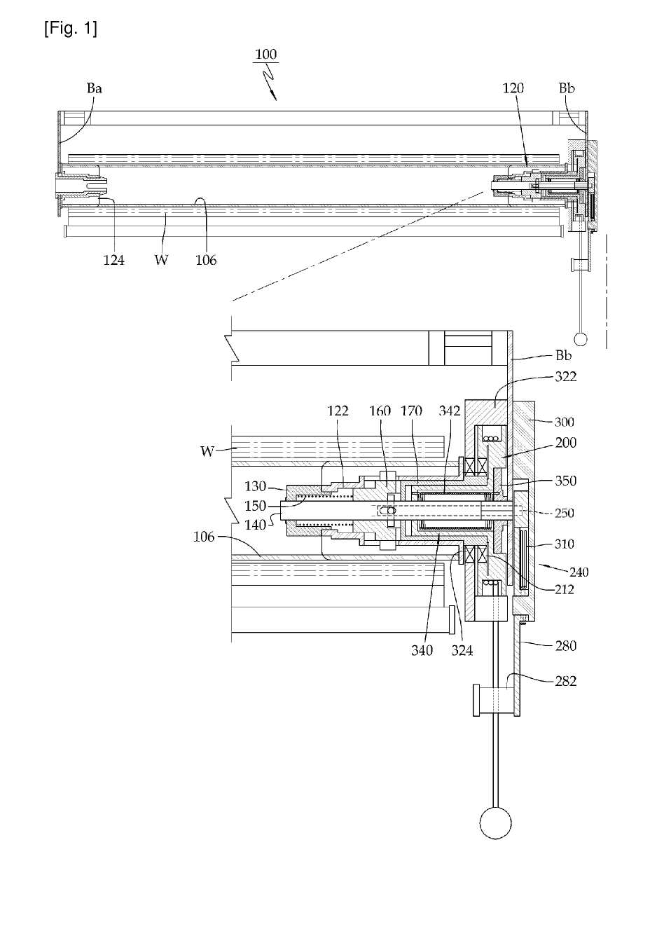

As shown in FIG. 1, the roll blind 100 with a single safety cord according to the present invention has features in that a blind sheet “W” is wound on a winding rod 106 and is kept or when in use it is unwound and rolled down from the winding rod 106.

The roll blind 100 with a single safety cord according to the present invention comprises a winding part 120 which allows a blind sheet “W” to ascend or descend.

The winding part 120 comprises a driving connector 122 at one side of the winding rod 106 on an outer surface of which is wound a blind sheet “W”. The driving connector 122 is inserted into an end of the winding rod 106.

A driven connector 124 is inserted into the other end of the winding rod 106, and the driven connector 124 is rotatably engaged to a bracket “Ba” of one side.

In the winding part 120, as the driving connector 122 and the winding rod 106 rotate in one direction, the blind sheet “W” wound on the winding rod 106 ascends.

As the driving connector 122 and the winding rod 106 rotate in the other direction, the blind sheet “W” unwinds and rolls down from the winding rod 106.

The winding part 120 is integrally fixed at an end of the driving connector 122 using a support cap 130. The support cap 130 is disposed with its center portion being rotatably inserted into a circular outer circumferential surface of a central shaft 140.

The central shaft 140 is disposed with its one end being fixed at the bracket “Bb” of the other side, with its other end extending toward a central portion of the winding rod 106 for thereby forming a free end.

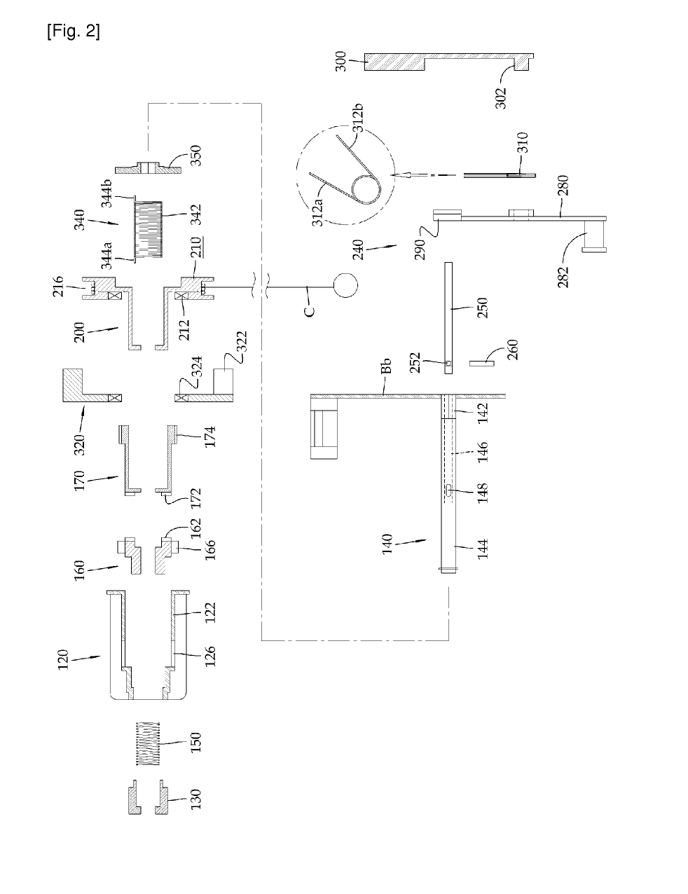

As shown in FIG. 2, the central shaft 140 forms a hexagonal part 142 with a hexagonal cross section and a rotation part 144 with a rotational cross section. The hexagonal part 142 is formed close to the bracket “Bb”, and the remaining portions form the rotation part 144 with a circular cross section.

The winding part 120 is positioned in such a way that a clutch recovery spring 150 is coaxially inserted into the surrounding portions of the central shaft 140 at an inner side of the support cap 130.

The clutch recovery spring 150 is disposed with its one side being supported by an inner surface of the support cap 130, with its other side being supported by a back surface of the movable clutch 160, which will be described later.

The clutch recovery spring 150 helps elastically support the movable clutch 160 all the time to be close to the side of a rotation clutch 170.

The present invention comprises an ascending operation part 200 configured to pull a single safety cord “C” toward a direct downward side for thereby ascending the blind sheet “W”.

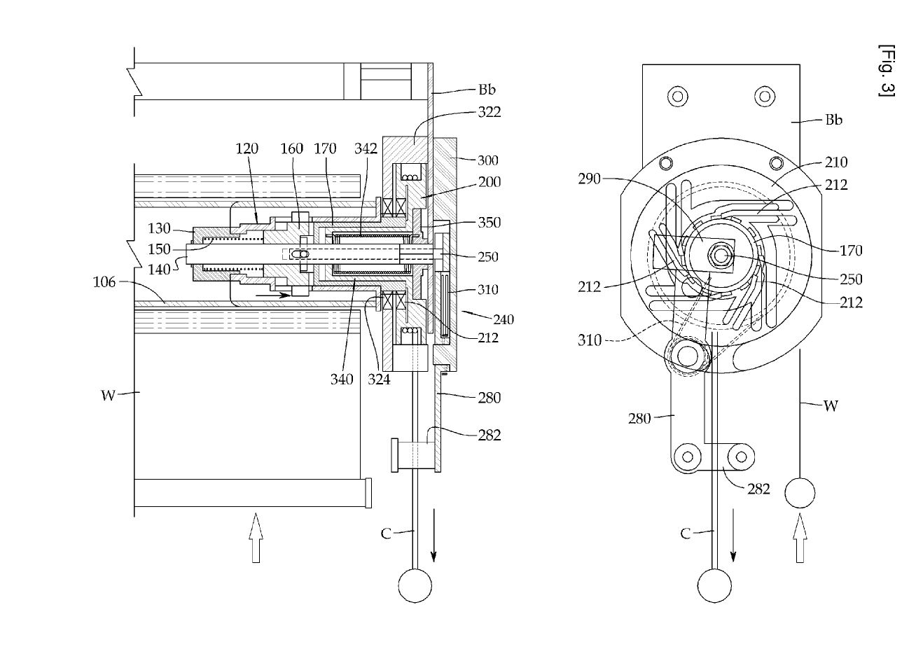

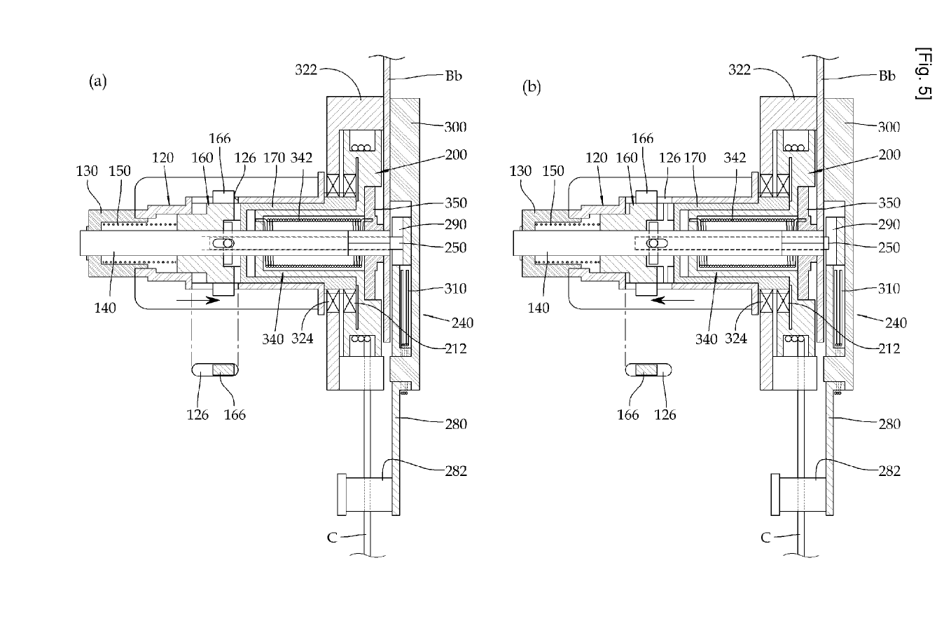

As shown in FIGS. 3 and 5A, the ascending operation part 200 comprises a movable clutch 160 which slides from an inner side of the driving connector 122 to an axial direction and is engaged.

The ascending operation part 200 is disposed close to the movable clutch 160 at an inner side of the driving connector 122 and comprises a rotation clutch 170 which is rotatable.

As shown in FIG. 2, the opposite clutches 162 and 172 of the movable clutch 160 and the rotation clutch 170 engage or disengage as the movable clutch 160 moves left or right.

The rotation clutch 170 is engaged to a cord pulley 210 as its one side is inserted rotatable at the inner side.

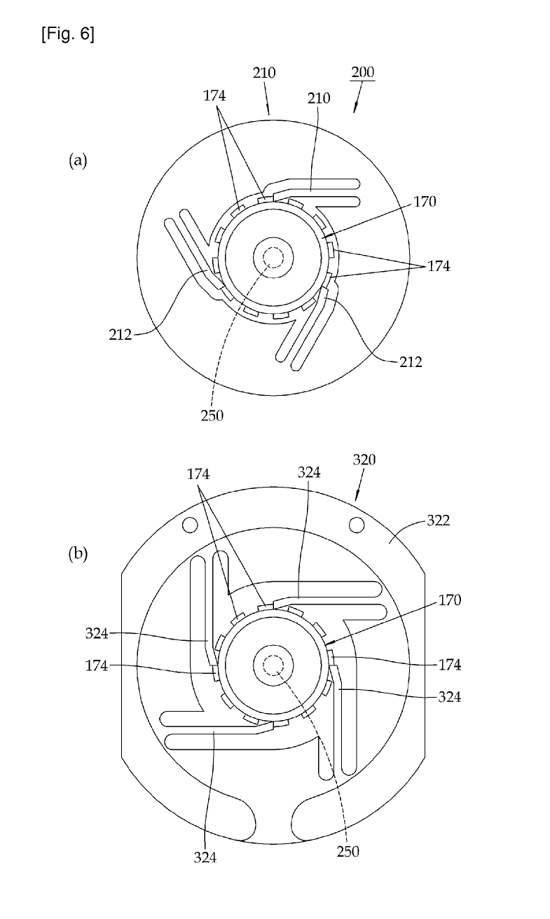

As shown in FIGS. 5A and 6A, the cord pulley 210 is configured in such a way that a plurality of first one-way poles protruding toward one side are tooth-engaged with one side of a tooth part 174 of one outer circumferential surface of the rotation clutch 170.

The ascending operation part 200 is configured to operate in such a way that in a state that the rotation clutch 170 and the movable clutch 160 are engaged, a user pulls in a right downward direction the single safety cord “C” wound on the cord pulley 210 for thereby ascending the blind sheet “W”.

As shown in FIGS. 2 and 5A, the ascending operation part 200 has features in that a plurality of sliding protrusions 166 are formed on an outer circumferential surface of the movable clutch 160.

The sliding protrusions 166 are movably inserted into a plurality of sliding grooves 126 formed in an axial direction on an inner circumferential surface of the driving connector 122.

The movable clutch 160 is inserted into the driving connector 122.

The movable clutch 160 therefore cannot have a rotation in a circumferential direction with respect to the driving connector, but can have a sliding movement in an axial direction of the central shaft 140 in the driving connector 122.

The ascending operation part 200 comprises a cord pulley 210 on which a single safety cord “C” is wound. As shown in FIGS. 2 and 5A, the cord pulley 210 comprises a ring shaped concave groove 216 on an outer circumferential surface of which is wound a single safety cord “C”.

From one side of the cord pulley 210 extent a plurality of first one-way poles 212 in an inward direction with a certain inclination. As shown in FIG. 6A, with a certain inclination, the first one-way poles 212 extend toward one side of the tooth part 174 of the outer circumferential surface of the rotation clutch 170, and the ends of them are engaged with the tooth part 174.

As the single safety cord “C” is pulled downward, when the cord pulley 210 rotates, the rotation clutch 170 can rotate in the same direction along with the cord pulley 210.

The present invention comprises a descending operation part 240 which allows the blind sheet “W” to descend freely as a user pulls forward the single safety cord “C”.

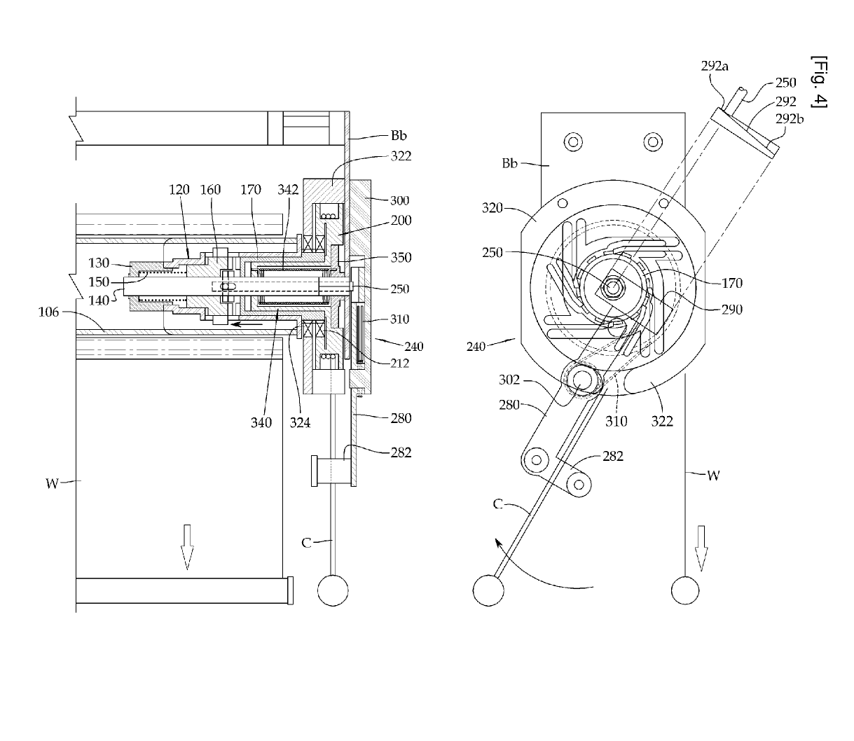

As shown in FIGS. 4 and 5B, the descending operation part 240 has features in that a rod shaped pusher 250 is so inserted that the movable clutch 160 can slide in a shaft hole 146 of the central shaft 140 which is inserted rotatable.

As shown in FIG. 2, the central shaft 140 and the pusher 250 are coaxially disposed, and the pusher 250 can slide in the interior of the central shaft 140.

The pusher 250 is disposed with an end of its one side passing through the bracket “Bb” where the central shaft 140 is fixed, and comes into close contact with an inclined surface 290 of the top of a descending adjusting lever 280.

At an end of the other side of the pusher 250 is disposed a pressing rod 260 in the interior of the central shaft 140.

Both ends of the pressing rod 260 protrude from either side of a longitudinal hole 148 formed in an axial direction at an intermediate portion of the central shaft 140.

More specifically, the pressing rod 260 formed in the pusher 250 is formed at a right angle with respect to the axial direction of the pusher 250.

The pressing rod 260 is inserted into a hole 252 formed in the pusher 250. In the pressing rod 260, the pusher 250 is inserted into the shaft hole 146 of the central shaft 140, and the longitudinal hole 148 of the central shaft 140 and the hole 252 of the pusher are matched.

Since the pressing rod 260 is inserted passing through the longitudinal hole 148 of the central shaft 140 and the longitudinal hole 252 of the pusher 250, both ends of the pressing rod 260 can be positioned and assembled in the longitudinal hole 148 of the central shaft 140.

As shown in FIG. 5A, both ends of the pressing rod 260 protrude outward from the longitudinal hole 148 of the central shaft 140 and are supported by one side of the movable clutch 160 and push the movable clutch 160 with respect to the recovery spring 150.

The descending operation part 240 comprises a descending adjusting lever 280 that the user can adjust by pulling forward the single safety cord “C”.

As shown in FIGS. 4 and 5B, the descending adjusting lever 280 is disposed with its lower end forming an engaging member 282 toward the front side of the single safety cord “C”.

The user can rotate the descending adjusting lever 280 with the aid of the engaging member 282 in such a way that the user pulls forward the single safety cord “C”.

As the descending adjusting lever 280 rotates, the pusher 250 can slide in the interior of the central shaft 140 with the aid of the inclined surface 290 of the top of the descending adjusting lever 280, and the movable clutch 160 is disengaged from the rotation clutch 170.

The disengagement of the movable clutch 160 makes the driving connector 122 and the movable clutch 160 rotate freely, so the blind sheet “W” can descend freely.

As shown in FIG. 2, in the descending operation part 240, an intermediate portion of the descending adjusting lever 280 is rotatably engaged at a hinge shaft 302 of the bottom of a support plate 300 fixed at the other side surface of the bracket “Bb”.

A torsion spring 310 is engaged at the hinge shaft 302, and the descending adjusting lever 280 can stand upright. The torsion spring 310 is disposed between the support plate 300 and the bracket “Bb”. An end 312a of one side of the torsion spring 310 is fixed at the descending adjusting lever 280, and an end 312b of the other side of the same is fixed at the support plate 300.

The torsion spring 310 can accumulate elastic recovery force during the operations of the descending adjusting lever 280.

In the descending operation part 240, when the user pulls forward the single safety cord “C” and pulls forward the engaging member 282 of the bottom of the descending adjusting lever 280, the torsion spring 310 stores elastic recovery force and bends.

When the descending adjusting lever 280 rotates with a certain inclination, a thick portion 292a in the inclined surface 290 of the top of the descending adjusting lever 280 comes into contact with one side of the pusher 250 and slides the pushed 250 in the interior of the shaft hole 146 of the central shaft 140.

As shown in FIG. 4, when the descending adjusting lever 280 rotates with an inclination, the inclined surface 290 moves and pushes the pusher 250 toward the thick portion 292a.

In this case, as shown in FIG. 5B, the opposite side of the inclined surface 290 is supported by the inner surface of the support plate 30, and the thick portion 292a of the inclined surface 290 pushes a side surface of the pusher 250.

As the thick portion 292a of the inclined surface 290 pushes a side surface of the pusher 250, the pressing rod 260 of the pusher 250 is positioned at a left side in the longitudinal hole 140, and the movable clutch 160 moves getting away from the rotation clutch 170, so the clutches 162 and 172 are disengaged.

When the clutches 162 and 172 are disengaged, the driving connector 122 and the movable clutch 160 become free rotation states with the aid of the weight of the blind sheet “W”, and the blind sheet “W” can freely roll down and descends.

When the user releases the forwardly pulled state of the single safety cord “C”, an elastic recovery force of the torsion spring 310 applies to the descending operation part 240.

The torsion spring 310 elastically stands upright as the descending adjusting lever 29 rotates in reverse direction.

When the descending adjusting lever 280 keeps standing upright, a thin portion 292b of the inclined surface 290 comes into contact with one side of the pusher 250.

In this case, as shown in FIG. 5A, the pressing rod 260 of the pusher 250 is positioned at a right side in the longitudinal hole 148 of the central shaft 140 by means of the movable clutch 160 which moves by a recovery force of the clutch recovery spring 150.

The clutches 162 and 172 of the movable clutch 160 and the rotation clutch 170 are engaged, and the rotations of the driving connector 122 and the movable clutch 160 stop, and the descending of the blind sheet “W” stops.

When the clutches 162 and 172 of the movable clutch 160 and the rotation clutch 170 are engaged, the reverse rotation prevention part 320 blocks the reverse rotation of the rotation clutch 170 and stops the descending of the blind sheet “W”.

As shown in FIG. 2, the reverse rotation prevention part 320 comprises brake latch 322 positioned at one side of the cord pulley 210. The top of the brake latch 322 is integrally fixed at the bracket “Bb”.

As shown in FIG. 6B, a plurality of second one-direction poles 324 protrude from the inner side of the brake latch 322 and tooth-engage with the other side of the tooth part 174 of an outer surface of the rotation clutch 170.

The reverse rotation prevention part 320 allows the second one-way poles 324 of the bracket latch 322 to prolong with an inclination side by side in the same direction as the first one-way poles 212 of the cord pulley 210.

The ends of the second one-way poles 324 are tooth-engaged with an inclination with the other side of the tooth part 174 of an outer surface of the rotation clutch 170 for thereby preventing the rotation clutch 170 from rotating in reverse direction.

When the clutches 162 and 172 of the movable clutch 160 and the rotation clutch 170 are engaged, the reverse rotation prevention part 320 blocks the reverse rotation of the rotation clutch 170 and stops the descending of the blind sheet “W”.

In the present invention, when the user pulls right down the single safety cord “C”, a cord returning part 340 ascends and returns the single safety cord “C” to its original position.

As shown in FIGS. 2 and 3, the cord returning part 340 comprises a pulley recovery spring 342 which accumulates elastic recovery force when the cord pulley 210 rotates in one direction by pulling down the single safety cord “C”.

The cord returning part 340 comprises a pulley recovery spring 342 arranged at a surrounding of the central shaft 140 at an inner side of the cord pulley 210.

The pulley recovery spring 342 is fixed at a bushing 350 with an end of one side of the pulley recovery spring 342 being fixed at an inner side surface of the cord pulley 210, with an end 344b of the other side of the pulley recovery spring 342 being inserted into a hexagonal part 142 of the central shaft 140.

In the cord returning part 340, when the cord pulley 210 rotates as a user pulls the single safety cord “C” downward, the pulley recovery spring 342 accumulates torsion elastic force.

In addition, when the downwardly pulled state of the single safety cord “C” is released by the user, the cord pulley 210 can rotate in reverse direction with the aid of the torsion elastic recovery force of the pulley recovery spring 342.

The single safety cord “C” winds on the cord pulley 210 and ascends and returns to its original position.

As shown in FIG. 6A, in the cord returning part 340, when the cord pulley rotates in reverse direction by means of the pulley recovery spring 342, the first one-way poles 212 of the cord pulley 210 elastically bend and move over one side of the tooth part 174 of an outer circumferential surface of the rotation clutch 170.

As shown in FIG. 6B, the reverse rotation of the rotation clutch 170 can be prevented since the second one-way poles 324 of the brake latch 322 are engaged with the other side of the toot part 174 of an outer circumferential surface of the rotation clutch 170.

The single safety cord “C” of the present invention is made shorter and is positioned higher where a kid's hand cannot reach.

In addition, the user can ascend the blind sheet “W” by pulling right downward the single safety cord “C”.

As shown in FIG. 3, when the user pulls right downward the single safety cord “C”, as shown in FIG. 6A, the cord pulley 210 rotates, and the first one-way poles 212 rotate the rotation clutch 170 in the same direction as the cord pulley 210.

As shown in FIG. 6B, the second one-way poles 324 of the brake latch 322 elastically bend, allowing the rotation of the rotation clutch 170. When the rotation clutch 170 rotates, the movable clutch 160 engaged with the clutches 162 and 172 rotate. The rotation of the movable clutch 160 causes the driving connector 122 to rotate.

The winding rod 106 engaged with the driving connector 122 rotates, and the blind sheet “W” wound on the winding rod 106 is wound on the winding rod 106 and ascends.

In the present invention, the user pulls right downward the single safety cord “C” wound on the cord pulley 210 for thereby ascending the blind cord “W”.

The downwardly pulled single sage cord “C” can automatically return to its original position by means of the cord returning part 340.

When the user pulls downward the single safety cord “C”, the pulley recovery spring 342 accumulates torsion elastic force with the aid of the rotation of the cord pulley 210.

When the downwardly pulled state of the single safety cord “C” is released, the cord pulley 210 can rotate in reverse direction using the torsion elastic recovery force of the pulley recovery spring 342.

The single safety cord “C” ascends and returns to its original position, the user can pull again the single safety cord “C” so as to further ascend the blind sheet “W”.

On the contrary, the user can pulls forward with an inclination the single safety cord “C” and descends the blind sheet “W”, so it is possible to freely adjust the height of the blind sheet “W”.

As shown in FIG. 4, the user can pull forward the single safety cord “C” so as to rotate the descending adjusting lever 280 with the aid of the engaging member 282.

By the inclined surface 290 of the top of the descending adjusting lever 280, the pushes slides in the interior of the central shaft 140, and the movable clutch 160 is disengaged from the rotation clutch 170.

The disengagement of the movable clutch 160 makes free rotations of the driving connector 122 and the movable clutch 160. By the weight of the blind sheet “W”, the driving connector 122 and the movable clutch 160 can freely rotate, so the blind sheet “W” can be freely descended.

As shown in FIG. 5A, when the user releases the pulled state of the single safety cord, the engagement of the clutches 162 and 172 of the movable clutch 160 and the rotation clutch 170 can be obtained.

The rotations of the driving connector 122 and the movable clutch 160 are stopped by the reverse rotation prevention part 320, and blind sheet “W” stops descending.

When the user pulls again forward the single safety cord “C”, the movable clutch 160 disengages from the rotation clutch 170, and the driving connector 122 and the movable clutch 160 can freely rotate by the weight of the blind sheet “W”, and the blind sheet “W” can freely descend.

The descending of the blind sheet “W” can be freely adjusted in such a way to pull forward the single safety cord “C” or to release the forwardly pulled state.

According to the present invention, when it needs to descend the blind sheet “W”, the single safety cord “C” is forwardly pulled, and the clutches 162 and 172 are disengaged, so the blind sheet “W” can be fast descended.

When it needs to ascend the blind sheet “W”, the single safety cord “C” is repeatedly pulled right downward, so the blind sheet “W” can be easily ascended.

According to the present invention, since the single safety cord “C” is made shorter and is positioned higher where a kid's hand does not reach, it is possible to effectively prevent accidents such as a kid's neck is choked or a kid or a weak person stumbles over and fall down.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A roll blind with a single safety cord for a roll blind device which is made to wind a blind sheet on a winding rod and store the wound blind sheet or when in use to unwind it from the winding rod, comprising:
a winding part by which as a driving connector connected to one side of the winding rod rotates in one direction, the blind sheet wound on the winding rod ascends, and as the driving connector and the winding rod rotate in the other direction, the blind sheet descends;
an ascending operation part including:
a movable clutch which slide-engages in an axial direction at an inner side of the driving connector; and
a rotation clutch which is rotatable at an inner side of the driving connector, wherein in the movable clutch and the rotation clutch, the opposite clutches are engaged or disengaged as the movable clutch moves left or right, and in a state that the rotation clutch and the movable clutch are engaged, the blind sheet can ascend by pulling right downward a single safety cord of the cord pulley connected to the rotation clutch; and
a descending operation part by which the blind sheet can descend in such a way to rotate the movable clutch and to disengage from the rotatable clutch by pulling forward the single safety cord and rotating a descending adjusting lever with the aid of an engaging member, wherein the descending adjusting lever is disposed at one side of the movable clutch, and a lower end of the descending adjusting lever forms the engaging member at a forward side of the single safety cord.

2. The blind of claim 1, wherein a support cap is integrally fixed at an end of one side of the driving connector, and a central portion of the support cap is rotatably inserted into a circular outer circumferential surface of the central shaft, and a clutch recovery spring is coaxially inserted into a surrounding of the central haft at an inner side of the support cap, and one side of the clutch recovery spring is supported by an inner surface of the support cap, and the other side of the clutch recovery spring is supported by a back surface of the movable clutch, and the movable clutch comes into close contact all the way toward the rotatable clutch and is elastically supported.

3. The blind of claim 2, wherein a plurality of sliding protrusions are formed on an outer circumferential surface of the movable clutch, and the sliding protrusions are movably inserted into a plurality of sliding grooves formed in an axial direction on an inner circumferential surface of the driving connector, so the movable clutch is prevented from rotating in a circumferential direction with respect to the driving connector and becomes movable in an axial direction of the central shaft in the interior of the driving connector, and the rotation clutch comprises a cord pulley, one side of the rotation clutch being rotatably inserted into the cord pulley, and a plurality of one-way poles protruding from the cord pulley are tooth-engaged with one side of a tooth portion of an outer circumferential surface of the rotation clutch, and in a state that the rotatable clutch and the movable clutch are engaged, when the single safety cord wound on the cord pulley is pulled right downward, the driving connector rotates in one direction with the aid of the rotations of the rotatable clutch and the movable clutch, so the blind sheet is wound on the winding rod and ascends.

4. The blind of claim 3, wherein a ring shaped concave groove on which to wind a single safety cord is formed at an outer circumferential surface of the cord pulley, and the plurality of the first one-way poles extend with an inclination toward one side of the tooth part of an outer circumferential surface of the rotation clutch at its one side, and the ends of the first one-way poles are tooth-engaged, and when the cord pulley rotates as the single safety cord is downwardly pulled, the cord pulley and the rotation clutch rotate in the same direction.

5. The blind of claim 2, wherein a circular rod-shaped pusher is inserted in the movable clutch so that the movable clutch can slide in the interior of the shaft hole of the central shaft, and an end of one side of the pusher passes through a bracket at which the central shaft is fixed, and comes into close contact with an inclined surface of the top of the descending adjusting lever, and an end of the other side of the pusher is disposed in such a way that a pressing rod protrudes in both directions from a longitudinal hole formed in an axial direction of the central shaft and is supported by one side of the movable clutch, and an intermediate portion of the descending adjusting lever is rotatably engaged at a hinge shaft of the bottom of a support plate fixed at a surface of the other side of the bracket, and a distortion spring is disposed in the hinge shaft, so that the descending adjusting lever can elastically stand upright, and when the movable clutch is disengaged from the rotation clutch by pulling the single safety cord forward, the blind sheet can unwind from the winding rod and descends as the weight of the blind sheet allows the driving connector and the winding rod to freely rotate in the direction of the other side.

6. The blind of claim 5, wherein when the engaging member of the bottom of the descending adjusting lever is pulled forward via the single safety cord, the distortion spring stores elastic recovery force and bends, and the descending adjusting lever rotates with an inclination, and a thick portion of the inclined surface of the top of the descending adjusting lever comes into contact with one side of the pusher and slides the pusher in the interior of the shaft hole, and the pressing rod of the pusher is positioned at one side in the longitudinal hole of the central shaft, and the movable clutch moves away from the rotation clutch, so the clutches are disengaged, and when the forwardly pulled state of the single safety cord is released, the torsion spring allows a thin portion of the inclined surface of the top of the descending adjusting lever to come contact with one side of the pusher, and the pressing rod of the pusher is positioned at the other side in the interior of the central shaft, so the clutches of the movable clutch and the rotation clutch are engaged, and the rotations of the driving connector and the winding rod are stopped, and the descending of the blind sheet is stopped.

7. The blind of claim 6, wherein the distortion spring is disposed in a space formed between the support plate and the bracket, and an end of one side of the distortion spring is fixed at the descending adjusting lever, and an end of the other of the distortion spring is fixed at the support plate, so elastic recovery force can be accumulated during the rotations of the descending adjusting lever, and an inner surface of the support plate supports a side surface of the opposite side of the inclined surface of the top of the descending adjusting lever, so the inclined surface can be supported by a side surface of the pusher.

8. The blind of claim 1, wherein at one side of the cord pulley is provided a reverse rotation prevention part which is formed of a brake latch one side of which is fixed at the bracket, for thereby preventing the rotation clutch from rotating in reverse direction, and in the brake latch, the second one-way poles are tooth-engaged with the other side of the tooth part of an outer circumferential surface of the rotation clutch, and the second one-way poles extend with an inclination side by side in the same direction as the first one-way poles, and the ends of the second one-way poles are tooth-engaged with an inclination with the other side of the tooth part of an outer circumferential surface of the rotation clutch for thereby preventing the rotation clutch from rotating in a reverse direction.

9. The blind of claim 1, further comprising:
a cord returning part formed of a pulley recovery spring which accumulates an elastic recovery force when the cord pulley rotates in one direction by pulling the single safety cord downward, the cord returning part rotating the cord pulley in reverse direction using an elastic force accumulated in the pulley recovery spring, and winding the single safety cord on the cord pulley and ascending and returning to its original position, and the pulley recovery spring is positioned around the central shaft at an inner side of the cord pulley, and an end of one side of the pulley recovery spring is fixed at an inner side surface of the cord pulley, and an end of the other side of the pulley recovery spring is fixed at a bushing which is fixedly inserted into a hexagonal part of the central shaft, and when the cord pulley rotates by the downward pulling of the single safety cord, the pulley recovery spring accumulates distortion elastic force, and when the downwardly pulled state of the single safety cord is released, the cord pulley is rotated in reverse direction by the distortion elastic recovery force of the pulley recovery spring, and the single safety cord is wound on the cord pulley and ascends and returns to its original position, and the user pulls again right downward the single safety cord, which has returned to its original position, for thereby further ascending the blind sheet, so the blind sheet can be ascended to a certain height by repeatedly performing the above procedures.

10. The blind of claim 9, wherein the cord returning part is configured in such a way that when the cord pulley rotates in reverse direction by means of the pulley recovery spring, the first one-way poles of the cord pulley elastically bend, and move over one side of the tooth part of an outer circumferential surface of the rotation clutch, and the reverse rotation of the rotation clutch is stopped as the second one-way poles of the brake latch are engaged with the other side of the tooth part of an outer circumferential surface of the rotation clutch.
